(19) United States
(12) Patent Application Publication
(10) Pub. No.: US 2010/0043008 A1
(43) Pub. Date: Feb. 18, 2010

(54) Scalable Work Load Management on Multi-Core Computer Systems

(76) Inventor: Benoit Marchand, Montreal (CA)

Correspondence Address: CARR & FERRELL LLP, 2200 GENG ROAD, PALO ALTO, CA, 94303, US

(21) Appl. No.: 12/543,443

(22) Filed: Aug. 18, 2009

Related U.S. Application Data
(60) Provisional application No. 61/189,358, filed on Aug. 18, 2008.

(51) Int. Cl. G06F 9/46

(52) U.S. Cl. 718/104; 718/105

(57) ABSTRACT

Embodiments of the presently claimed invention minimize the effect of Amdahl's Law with respect to multi-core processor technologies. This scheme is asynchronous across all of the cores of a processing system and is completely independent of other cores and other work units running on those cores. This scheme occurs on an as needed and just in time basis. As a result, the constraints of Amdahl's Law do not apply to a scheduling algorithm and the design is linearly scalable with the number of processing cores with no degradation due to the effects of serialization.

### CROSS-REFERENCE TO RELATED APPLICATIONS

The present application claims the priority benefit of U.S. provisional patent application No. 61/189,358 filed Aug. 18, 2008 and entitled “Method for Scalable Work Load Management on Multi-Core Computer Systems,” the disclosure of which is incorporated herein by reference.

### BACKGROUND OF THE INVENTION

1. Field of the Invention

The present invention generally relates to work load management. More specifically, the present invention relates to dynamic resource allocation on computer systems that make use of multi-core processing units. The present invention further relates to networks of computers with a plurality of computational nodes, which may further implement multi-core processing units.

2. Description of the Related Art

Amdahl's law is a model for the relationship between the expected speedup of parallelized implementations of an algorithm relative to the serial algorithm, under the assumption that the problem size remains the same when parallelized. The law is concerned with the speedup achievable from an improvement to a computation that affects a proportion P of that computation where the improvement has a speedup of S. Amdahl's law states that the overall speedup of applying the improvement will be:

$$\frac{1}{( 1 - P ) + \frac{P}{S}} .$$

Assume that the run time of an old computation was 1 for some unit of time. The run time of the new computation will be the length of time the unimproved fraction takes, which is (1−P), plus the length of time the improved fraction takes. The length of time for the improved part of the computation is the length of the improved part's former run time divided by the speedup thereby making the length of time of the improved part (P/S). The final speedup is computed by dividing the old run time by the new run time as formulaically reflected above.

In the case of parallelization, Amdahl's law states that if P is the proportion of a program that can be made parallel (i.e., benefit from parallelization) and (1−P) is the proportion that cannot be parallelized (i.e., remains serial), then the maximum speed up that can be achieved by using N processors is:

$$\frac{1}{( 1 - P ) + \frac{P}{N}} .$$

In the limit, as N tends to infinity, the maximum speedup tends to 1/(1−P). In practice, performance to price ratio falls rapidly as N is increased once there is even a small component of (1−P). For example, if P is 90%, then (1−P) is 10% and the problem can be sped up by a maximum of a factor of 10 no matter how large the value of N used.

FIG. 1 illustrates, in accordance with Amdahl's Law, that as the number of processing elements (e.g., processing cores and/or processing machines) is increased, the additional performance of the ensemble of such processing elements asymptotically tends to a limit. Under these circumstances, adding additional processing elements results in asymptotically less benefit to the processing of the algorithm in use. This effect is universal and is related to the ratio between the serial and parallel components of the algorithm. While the actual rate of convergence of the performance curve to the asymptote, and the value of the asymptote itself, is related to the proportion of serialization in the algorithm, even highly parallel algorithms converge after a small number of processing elements.

In this context, it is noted that at a very basic level, there is the need to schedule a stream of work load units (often referred to as jobs) for execution on a computer system and to then manage the execution of the jobs in an orderly manner with some goal in mind. Recognizing that any particular job may not complete for some reason, a management scheme would require enhancements that allow it to deal with exceptions to the simple process of ordering one job to execute when its predecessor completes. The management scheme may, for example, detect an endlessly repeating loop in a running job and terminate execution of that job so that the next job in the input queue can be dispatched.

The work load manager components of a modern operating system generally implement a broad range of features that provide for sophisticated management of the work load units in execution on a computer system. The allocation of resources needed to enable execution of the instructions of a work load unit is scheduled in time and quantity of the resource based on availability. A job scheduler will be designed to achieve some goal, such as the fair or equitable sharing of resources amongst a stream of competing work units, the implementation of priority based scheduling to deliver preference to some jobs over others, or such other designs that implement real time responsiveness or deadline scheduling to ensure that specified jobs complete within specified time periods.

In order to make an allocation of the resources needed to dispatch a job, the job scheduler must know the resource requirements of a job and the availability of resources on the computer system at the moment of job dispatch. A sampling scheme can typically be used to make such a comparison whereby the job scheduler can sample the resource status on the computer system, then determine if the resource requirements of a job represent a proper subset of the available resources. If so, the job scheduler can make an allocation and dispatch the job. Otherwise, the job must be held pending the availability of inadequate resource elements.

FIG. 2 illustrates work load scheduling 200 for a single-core computing system as may be found in the prior art. The operating system of a computer arranges for the periodic generation of scheduling events, typically by using a clock to interrupt the running state 210 of the computer system. The clock interrupt may also initiate a sequence of processing actions that first queries or samples the state of system resource utilization 220, reads a scheduling policy 230 and allocates resources to work load units in a request queue 240, schedules the dispatch of work load units 250, and then resumes the running state of the computer system 260.

In the context of a single core processing system, a sampling methodology may operate as a sufficient and effective method of determining a resource availability profile. In the context of a multi-core computer system, however, using such prior art methodologies results in a multiplication of the sampling operation over the number of processing elements. Each of these elements must be individually sampled individually to estimate the global state of the resource consumption or, consequently, the resource availability. In the general context of this approach, all of the processing elements of the computer system would have to be interrupted and held inactive if a completely consistent survey of the state of resources on the computer facility is to be obtained.

FIG. 3 illustrates sample-based scheduling 300 on a multi-core computer system with N processing cores as might occur in the prior art. Each of N processing cores is interrupted by a clock in step 310 and subsequently sampled in step 320. An allocation exercise is carried out in step 330 based on a system scheduling policy whereby N schedules are developed for the dispatching of the work load units 340. The N running states are finally resumed in step 350. A serialization issue (as discussed in further detail below) arises because all of the processors are held in the interrupted state (step 310) until a consistent view of resource consumption is determined and appropriate dispatching schedules for work load units can be constructed and the processor states resumed (step 350).

As the number of processing cores grows, so does the sampling rate. This growth is inevitable if not necessary because the individual processing cores are all executing independent and asynchronous tasks, which can change resource consumption profile at any time. In this scenario, as the number of cores increases, the sampling rate necessarily must increase to ensure that resource consumption profiles are up to date. Ultimately, the sampling activity will come to dominate the scheduling activity and the overall efficiency of the computer system suffers, which may sometimes be characterized as suffering from the law of diminishing returns.

An additional issue with the sampling approach is that as the frequency of sampling increases, the error of the sampled state of the system likewise increases. This increase in error is due to the fact that each sample of an element of the ensemble of processing elements has an inherent error due to the finite time needed to carry out the sampling operation. Over the ensemble, the aggregate error is multiplicative of the individual errors. By increasing the number of processing elements, the utility of the aggregated sample tends towards zero.

As referenced above, in the context of the parallelization of an algorithm, sampling based approaches introduce a single point of serialization into a scheduling algorithm. A consistent view of resource availability depends on obtaining the state of resource consumption on each of a plurality of processing cores. Since each core will generally be asynchronously executing an independent work unit, a sampling design imposes a point of serialization if the global resource state is to be known. This serialization occurs at the point that the states of the processing cores are interrupted (step 310 in FIG. 3) and held in interrupt until the sampling activity is completed (step 350). Further, the resources in use on a multi-core system are shared by the independent processing elements. Sharing imposes the serialization effect of sampling approaches. Thus, in order to get a consistent sampled view, the resource consumption profile of each of the tasks sharing the system resources must remain static during the sampling process.

There is, therefore, a need in the art to eliminate the effects of Amdahl's Law in the context of multi-core processing technologies, which otherwise limits the ability to scale up the benefits of using multi-core processor technologies congruent with the number of additional cores and/or processing units being deployed.

### SUMMARY OF THE CLAIMED INVENTION

Embodiments of the presently claimed invention minimize the effect of Amdahl's Law with respect to multi-core processor technologies. Through implementation of embodiments of the present invention, the benefits of using multi-core processor technologies with an increased number of cores or processing units may be enjoyed.

### BRIEF DESCRIPTION OF THE DRAWINGS

FIG. 1 illustrates the correlation between the number of processing elements and ensemble performance in accordance with Amdahl's Law.

FIG. 2 illustrates work load scheduling for a single-core computing system as may be found in the prior art.

FIG. 3 illustrates sample-based scheduling on a multi-core computer system with N processing cores as might occur in the prior art.

FIG. 4 illustrates an accounting based approach to resource scheduling in a multi-core computer system.

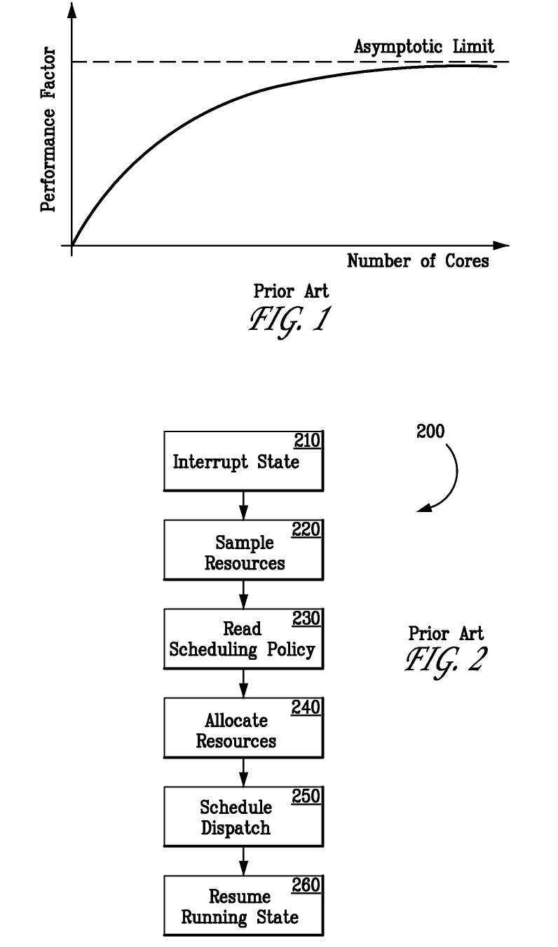

### DETAILED DESCRIPTION

Certain terminology utilized in the course of the present disclosure should be interpreted in an inclusive fashion unless otherwise limited by the express language of the claims. Notwithstanding, the following terms are meant to be inclusive of at least the following descriptive subject matter.

A processor core is inclusive of an electronic circuit design that embodies the functionality to carry out computations and input/output activity based on a stored set of instructions (e.g., a computer program).

A multi-core processor is inclusive of a central processing unit of a computer system that embodies multiple asynchronous processing units, each independently capable of processing a work load unit, such as a self contained process. Processor cores in a multi-core computer system may be linked together by a computer communication network embodied through shared access to common physical resources, as in a current generation multi-core central processor computer chip, or the network may be embodied through the use of an external network communication facility to which each processing core has access.

A work load unit is inclusive of a sequence of one or more instructions or executable segments of an instruction for a computer that can be executed on a computer system as a manageable ‘chunk.’ A work load unit encompasses the concept of a job, a process, a function, as well as a thread. A work load may be a partition of a larger block of instructions, as in a single process of a job that encompasses many processes. A work load unit is bounded in either time or space or both such that it may be managed as part of an ensemble of such work load units. The work load units are managed by a mechanism that can allocate resources needed to execute instructions that make up the work load unit on the computer system and manage the execution of the instructions of the work load unit by methods that include, but are not limited to, starting, stopping, suspending, and resuming execution.

A job scheduler is inclusive of a software component, usually found in an operating system, and that is responsible for the allocation of sufficient quantities of the resources of a computer system to a work load unit so that it can successfully execute its instruction stream on the central processing unit of the computer.

An allocatable resource of a computer facility is inclusive of any computer resource that is necessary for the execution of work load units in the facility and which can be shared amongst multiple work load units. Examples of allocatable resources include, but are not limited to, central processor time, memory, input/output bandwidth, processor cores, and communications channel time.

In an effort to minimize the effects of Amdahl's Law, embodiments of the present invention implement an alternative to prior art sampling approaches by means of accounting. Through accounting, embodiments of the present invention propose a scheme where the consumption of computer resources is accounted for at the point of allocation, or release, to or from a specific work unit, or to or from the resource configuration of the processing facility. At each event affecting the resource availability profile of the processing facility, the resource availability balance is updated to reflect the change. The detrimental issues associated with sampling and described above are avoided such that a current resource balance is available for use in allocation exercises.

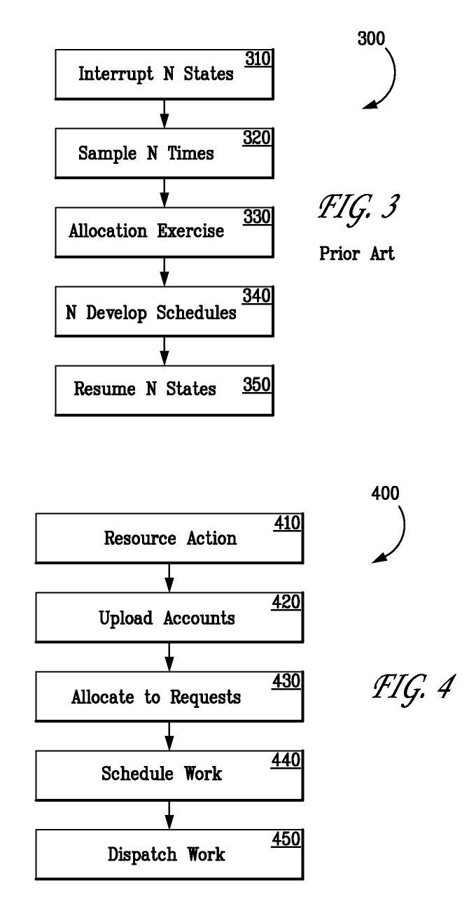

FIG. 4 illustrates an accounting based approach 400 to resource scheduling in a multi-core computer system. The approach of FIG. 4 does not involve serialization of a global resource scheduling algorithm running on a multi-core computer system and depicts what happens on a single processing element of the computer system when a resource availability event occurs.

An application, which is an instance of a work load unit such as a job, a process, a thread or any manageable quantity of work for a processing element, initiates a request to modify its own resource consumption profile in step 410. Within its own execution context, the application updates, in step 420, the resource availability profile for the processing element on which it is running. In the context of a dynamically changing resource configuration for a computer system, any change to resource configuration may also be considered during the accounting operation.

The necessary allocation action that results in work scheduling and that compares the updated resource availability profile to the current resource request profile is also examined (step 430), again within the running context of the processor, and used as input to the process scheduler for the computer system. This examination may occur in the context of one or more policies. At this point, the application context is interrupted and, depending on the result of the preceding allocation operation (step 430), the work load unit may be resumed, or supplanted by some other pending work load request in step 440.

The scheduling activity for each of the processors of the computer system is independent, asynchronous, but carried out in parallel without any serializing element in a scheduling algorithm. As a result, Amdahl's Law does not affect the disclosed methodology. The methodology of the present invention is, therefore, linearly scalable with the number of processor elements in the computer processing facility.

In implementation, an account for each allocatable resource of the computer system is initialized to a value of 100 percent of the total resource quantity available on the computer system. Any action by the job scheduler (e.g., at step 440) to allocate a resource is then accounted for against the global account for that resource by decrementing the account by the amount of the allocation (e.g., at step 420). Whenever a work unit such as an application releases a resource as might occur at step 410, either by terminating, or specifically releasing the resource, the global account for that resource is incremented by the quantity of the resource released.

In a similar manner, a work unit may, during the process of executing on a processing core, release a resource (again, at step 410) that it previously acquired. An accounting operation is again carried out at step 420 to update the global account for the resource.

Where a computer processing facility can be subject to dynamic changes to its resource configuration, either through the intended or unintended augmentation or reduction of its resource compliment, the accounting method may be used to update the resource availability profile at the point in time that the resource configuration change is recognized. Such recognition may occur as a result of information exchange between the computer operating system and the accounting mechanism. Recognition may also be initiated through direct configuration actions by external agents, such as the operator of the computer processing facility.

The result of the accounting method is, at all times, a current account balance of all allocatable resources of the computer system. Work unit management, therefore, has available all of the information needed by a job scheduling process in steps 430 and 440 to effectively map resource requests of resource availability without the need for a sampling operation.

In some embodiments of the aforementioned methodology, the operation that maps resources to work load units is initiated only at times where there is a change in the resource availability profile. If there is no change in resource availability, there is no need to reconsider the current allocation of resources against requests. When a change of resource availability occurs, either because a work unit acquired a quantity of resource, or because a work unit released a quantity of resource, a re-allocation exercise is warranted.

A change in resource availability initiated by a process running on a core of a computer system itself initiates the update of the global resource accounting and carries out a re-allocation operation of resources against resource availability using the updated global resource balance. This scheme is asynchronous across all of the cores of the processing system and is completely independent of other cores and other work units running on those cores. This scheme occurs on an as needed and just in time basis. As a result, the constraints of Amdahl's Law do not apply to the scheduling algorithm and the design is linearly scalable with the number of processing cores with no degradation due to the effects of serialization.

Computer-readable storage media refer to any medium or media that participate in providing instructions to a central processing unit (CPU), which may include a multi-core processor, for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge. The various methodologies discussed herein may be implemented as software and stored in any one of the aforementioned media for subsequent execution by a processor, including a multi-core processor.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The present descriptions are intended to cover such alternatives, modifications, and equivalents as may be included within the spirit and scope of the invention as defined by the appended claims and otherwise appreciated by one of ordinary skill in the art. The steps of various methods may be performed in varying orders while achieving common results thereof. Various elements of the disclosed system and apparatus may be combined or separated to achieve similar results. The scope of the invention should be determined not with reference to the above description, but instead should be determined with reference to the appended claims along with their full scope of equivalents.

What is claimed is:

1. A method for the management of work load units being processed on a computer system with a multi-core processor configuration, wherein the system is linearly scalable with the number of processor cores of the computer system with no loss of performance.

2. A method for the management of work load units being processed on a computer system with a multi-core processor configuration, wherein the system makes use of an asynchronous event based control mechanism for the management of the work load units executing on a computer system.
